(19) United States
(12) Patent Application Publication
(10) Pub. No.: US 2021/0155159 A1
(43) Pub. Date: May 27, 2021

(54) VEHICLE DISPLAY APPARATUS

(71) Applicant: NIPPON SEIKI CO., LTD., Niigata (JP)

(72) Inventors: Tamito KAWATE, Niigata (JP); Makoto HADA, Niigata (JP); Hiroyuki MITSUMOTO, Niigata (JP)

(21) Appl. No.: 17/047,618

(22) PCT Filed: May 14, 2019
(86) PCT No.: PCT/JP2019/019099

§ 371 Date: Oct. 14, 2020

(30) Foreign Application Priority Data
May 15, 2018 (JP) 2018-093982

(51) Int. Cl. B60R 1/00

(52) U.S. Cl. CPC B60R 1/001; B60R 2300/8093; B60R 2300/205; B60R 2300/308

(57) ABSTRACT

A head-up display apparatus prevents a driver from being confused when, for example, the number of overlaid images for alerting or emphasizing that are overlaid on an object increases due to the cutting-in of another vehicle, resulting in overlap between the overlaid images or between an overlaid image and another object resulting in an unclear correspondence relationship between the overlaid images and objects. A display control unit has: an overlap determination unit that, if a first overlay image is overlaid on a first object and a second object as a cut-in object is detected, determines the presence or absence of overlap between the overlaid images or the like; and a visibility control unit that, if the overlap occurs, makes the visibility of the first overlay image overlaid on the first object lower than the visibility of the second overlay image overlaid on the second object.

### TECHNICAL FIELD

The present invention relates to a vehicle display apparatus mounted on a vehicle such as an automobile.

### BACKGROUND ART

Patent Document 1 describes a head-up display (HUD) apparatus that detects a preceding vehicle traveling in front of a host vehicle, and displays the preceding vehicle with an emphasized display (overlaid image display) that uses a frame.

### PRIOR ART DOCUMENT

### Patent Document

Patent Document 1; Japanese Unexamined Patent Application Publication No. 2017-30600 (FIG. 3 and FIG. 7)

### SUMMARY OF THE INVENTION

### Problems to be Solved by the Invention

For example, when a preceding vehicle is present in front of a traveling vehicle, and an overlaid image for alerting or emphasizing or the like is being displayed on the preceding vehicle, if another vehicle cuts in between the host vehicle and the preceding vehicle, an overlaid image is also displayed on the vehicle that cut in (cut-in vehicle); however, at this time, the overlaid image of the cut-in vehicle may overlap (often by partially overlapping) the preceding vehicle or the overlaid image of the preceding vehicle.

The cut-in vehicle poses a greater relative danger than the preceding vehicle, and is the object that requires the most attention of the driver (user); however, as described above, when the overlaid image of the cut-in vehicle overlaps (or partially overlaps) the preceding vehicle or the overlaid image of the preceding vehicle, the correspondence relationship between the overlaid images and objects becomes unclear (uncertain) and may cause the driver (user) to become confused. In this case, for example, there is a concern that adverse effects may arise, such as the driver (user) requiring a longer time to accurately grasp the situation of the cut-in vehicle.

Patent Document 1 does not elaborate on this problem, and does not describe any countermeasures thereof.

An object of the present invention is, with respect to a head-up display (HUD) apparatus or the like, to prevent a driver (user) from becoming confused when, for example, the number of overlaid images for alerting or emphasizing or the like that are overlaid on an object increases due to the cutting-in of a vehicle, resulting in overlap between the overlaid images or between an overlaid image and another object, and causing an unclear correspondence relationship between the overlaid images and objects.

Other objects of the present invention will become apparent to those skilled in the art by referring to the aspects and the best embodiment exemplified below, and to the attached drawings.

### Solution to Problem

Aspects of the present invention are exemplified below to allow the summary of the present invention to be easily understood.

A first aspect is a vehicle display apparatus mounted on a vehicle, and including at least a head-up display (HUD) that projects an image on a projection target member provided in the vehicle that causes a driver to visually recognize a virtual image of the image, and the virtual image includes a virtual image of an overlaid image overlaid on a real view of the surroundings of the vehicle,
the vehicle display apparatus comprising
a display control unit that acquires a position of an object included in the real view of the surroundings of the vehicle that can be an overlay target of the overlaid image, and displays the overlaid image overlaid on the detected object, wherein
the display control unit includes an overlap determination unit that, if a first overlaid image is overlaid on a first object and a second object is detected as a cut-in object, determines the presence or absence of overlap between a second overlaid image, which is overlaid on the second object, and the first overlaid image or the first object, or the presence or absence of overlap between the first overlaid image and the second object, and
a visibility control unit that, if the overlap has occurred, makes a visibility of the first overlaid image lower than a visibility of the second overlaid image.

According to the first aspect, if a second overlaid image (note that an overlaid image is to be broadly interpreted, and is sometimes referred to as an overlaid display, overlaid content, an emphasis display, an emphasis mark, an alerting display, an alerting mark, or the like) overlaid on a second object, which is a cut-in object, overlaps (or partially overlaps) a first overlaid image overlaid on a first object, such as a preceding vehicle, or the first object itself, or there is overlap between the first overlaid image and the second target object, a display control is executed that makes the visibility of the first overlaid image lower than the visibility of the second overlaid image.

For example, the display luminance of the first overlaid image (which is sometimes represented by a transmittance) made lower than the display luminance of the second overlaid image. As a result, for example, even if the overlaid images partially overlap each other, the relatively increased visibility of the second overlaid image enables it to be easily distinguished from the first overlaid image, and therefore, the attention of the driver (user) can be focused (directed) without delay or confusion toward the second object (or in other words, a cut-in object that has newly appeared (such as a cut-in vehicle)), and further, the driver (user) is capable of quickly recognizing (for example, intuitively recognizing) the cut-in object (such as a cut-in vehicle). Therefore, when danger exists, it becomes easier to take an appropriate measure such as stepping on the brakes or avoiding a collision by operating the steering wheel with an appropriate timing, and the convenience of the vehicle display apparatus, such as the HUD (head-up display), is improved.

Note that the “visibility” refers to how easily visual confirmation can be made on sight. In addition to changing the luminance or brightness of an overlaid image, the methods of changing the visibility are exemplified by changing the shapes, patterns, colors, or connections of a symbol (such as geometric shape) or character that constitutes the overlaid image, changing the thickness of the lines that constitute a symbol (such as a geometric shape), changing the thickness of a character, adding a character or the like for attracting attention to a symbol, and changing the light emission state (for example, blinking) of a symbol (however, the present invention is not to be interpreted as being limited to these).

A second aspect is the vehicle display apparatus according to the first aspect, wherein
the visibility control unit, given a visibility of the first overlaid image of Q1a when the vehicle and the first object are at a first distance, a visibility of Q1b at a second distance which is shorter than the first distance, and a visibility of the second overlaid image of Q2, may control a display of the first overlaid image such that Q2>Q1a>Q1b.

According to the second aspect, a control is similarly executed that makes the visibility of the first overlaid image lower than the visibility of the second overlaid image; however, in the second aspect, the extent that the visibility is lowered is varied depending on the distance between the host vehicle and the first object (an existing preceding vehicle or the like).

For example, if another vehicle cuts in when the inter-vehicle distance between the host vehicle and the preceding vehicle (first object) is large (a first distance), it can be assumed that the inter-vehicle distance with the cut-in vehicle is usually relatively large with some room to spare. In contrast, if another vehicle cuts in when the inter-vehicle distance between the host vehicle and the preceding vehicle (first object) is small (when the distance is a second distance), then it is highly probable that the vehicle has very aggressively cut into a small space, and it can be assumed that the inter-vehicle distance with the cut-in vehicle (second object) is relatively small with little room to spare, and the situation is more dangerous.

Therefore, the visibility of Q1b of the second overlaid image in the latter case (when the inter-vehicle distance with the first object is the second distance, which is smaller than the first distance), is controlled such that it made lower than the visibility of Q1a of the second overlaid image in the former case (when the inter-vehicle distance with the first object is the first distance).

If the second overlaid image of the cut-in vehicle (second object), which more closely positioned from the perspective of the host vehicle, has a visibility of Q2, then the relationship Q2>Q1a>Q1b is established. When there is overlap between the second overlaid image and the first overlaid image and the like, the relative difference in visibility (visibility drop: e.g. contrast) is larger when the visibilities of the images are Q2 and Q1b than when the visibilities of the images are Q2 and Q1a, and it becomes less likely for attention to be directed toward the first object and more likely for attention to be directed toward the second object. Therefore, the cut-in vehicle (second object) is more emphasized and more likely to draw the attention of the driver (user). In other words, when there is more danger, the attention of the driver (user) can be more focused (directed) toward the cut-in vehicle (second object). As a result, brake and steeling wheel operations and the like are more likely to be performed without delay, and as a result, it is possible to obtain an effect such as increasing the probability of risk avoidance.

A third aspect is the vehicle display apparatus according to the first or second aspects, wherein
the display control unit, if a first overlaid image is being overlaid on a first object, and an object having a higher relative speed than a relative speed between the vehicle and the first object is newly detected in front of the first object, may identify the detected object as the second object, which is the cut-in object, and cause the overlap determination unit to execute overlap determination processing and the visibility control unit to execute visibility reduction processing.

According to the third aspect, when an object (overlay target) on which an overlaid image is to be displayed newly appears in front of the first object (an existing preceding vehicle or the like), and the relative speed of the newly appeared object (overlay target), when referenced to the host vehicle, is higher than the relative speed of the first object, then the newly appeared object (overlay target) is identified as the second object, which is the cut-in object, and further, when an overlap has occurred between the overlaid images or the like, the visibility control according to one of the aspects above is executed.

As an example of a case where an object (overlay target) representing an overlay target of the overlaid image newly appears in front of the first object, such as a preceding vehicle, a case is plausible where another vehicle traveling at high speed passes the host vehicle, and then additionally passes the preceding vehicle in front of the host vehicle and changes course into the same driving lane as the host vehicle; however, in this case, the overlay target is positioned further away than the preceding vehicle and the like (first object) and is also moving further away from the host vehicle, and therefore, the danger is not considered to be very high, and the need to focus (direct) the attention of the driver (user) on the overlay target is considered to be low.

However, when an object (overlay target) representing an overlay target of the overlaid image newly appears in front of the first object, such as a preceding vehicle, and the overlay target is, for example, a stationary object (such as an object that has fallen from the loading platform of a preceding truck, a rock caused by a landslide, a protrusion caused by an earthquake, or a car that has stopped in the driving lane due to a sudden breakdown), or is not a stationary object but is an object whose travel speed is very slow (such as an automobile with elderly passengers, an agricultural cultivator traveling on the road, or a snowplow traveling while removing snow), the inter-vehicle distance with the host vehicle will immediately become small such that delayed discovery will cause the possibility of a collision to increase, and therefore, such an overlay target can be considered a highly dangerous object.

In this case, the relative speed of the overlay target, when referenced to the host vehicle, is higher than the relative speed of the first object (such as a moving object which is traveling so as to maintain the inter-vehicle distance with the host vehicle). Therefore, in such a case, if there is overlap between, for example, the overlaid image of the overlay target and the overlaid image of the first object (first overlaid image) positioned behind it (or overlap with the first object), the overlay target is identified as the second object (cut-in object) of the aspects described above so that the attention of the driver (user) can be focused (directed) toward the overlay target, and further, the display control described in the aspects above (a display control that lowers the visibility of the first overlaid image so that the second overlaid image of the second object is more emphasized) is executed.

As a result, even in a situation where an object (first object) is present in front of the host vehicle, and an additional object (a stationary object or a near-stationary object) with a large relative speed unexpectedly appears in front of the object, the driver (user) can direct attention to the object which is more dangerous than the first object without delay, and can take an appropriate measure with an appropriate timing. Therefore, the convenience of the vehicle display apparatus is improved.

A fourth aspect is the vehicle display apparatus according to any one of the first to third aspects, wherein
if the number of first objects is two or more,
the visibility control unit may make the visibility of the first overlaid image of each of the two or more first objects lower than the visibility of the second overlaid image, and change the extent that the visibility is lowered according to a distance between the vehicle and each of the two or more first objects, or
uniformly make the visibility lower than the visibility of the second overlaid image.

According to the fourth aspect, if the number of first objects is two or more, by lowering the visibility of the first overlaid image of each first object according to the distance from the vehicle (host vehicle), it is possible to perform a visibility control that lowers the visibility as the distance increases such that, for example, the visibility of the second overlaid image of the cut-in vehicle (second object) is the highest, the visibility of the first overlaid image of the nearest object among the two or more first objects is the next highest, and so on. As a result, the driver (user) is capable of intuitively recognizing (grasping) the distance to each object or the level of danger of each object, and therefore, even in a case where a plurality of overlay targets are present, an appropriate measure can be taken while paying appropriate attention to each target, and paying the greatest attention to the cut-in object (second object).

Furthermore, when the number of first objects is two or more, by uniformly lowering the visibility of the first overlaid image of each first object, the driver (user) is capable of paying the maximum attention to the cut-in object (second object), and further, because the visibility of the two or more first objects is uniformly lowered, the possibility of visual confusion is also reduced.

A fifth aspect is the vehicle display apparatus according to any one of the first to fourth aspects, wherein the overlaid image may be displayed in at least either of a virtual image displayable area in the head-up display (HUD) apparatus, or a display area of a display apparatus disposed in front of the driver.

According to the fifth aspect, the display of the overlaid image may be realized using a head-up display (HUD) apparatus, and may also be realized by a display apparatus (which is broadly interpreted to include various displays such as liquid crystal displays, and composite display boards) disposed in front of the driver. In other words, the overlaid image can be displayed by at least one display means. As a result, it is possible to appropriately display a captured image of the area behind the vehicle and the like by using at least either of a virtual image or a real image, and therefore, the convenience to the driver greatly improves.

A sixth aspect is the vehicle display apparatus according to any one of the first to fifth aspects, wherein
each of the first and second overlaid images may include a frame image that encloses each of the first and second objects.

When the overlaid image is an image that encloses the object with a frame (which can be of any shape, such as a square frame or a circular frame), although there is an advantage that the object can be emphasized more clearly, the area of the graphic constituted by the frame becomes large, and the frames are more likely to overlap with each other. Therefore, the visibility control described above is effective.

Those skilled in the art will readily understand that the embodiments exemplified according to the present invention may be further modified without departing from the spirit of the invention.

### BRIEF DESCRIPTION OF THE DRAWINGS

FIG. 1(A) is a diagram showing a display example of a vehicle display apparatus including at least a head-up display (HUD); FIG. 1(B) is a diagram showing an example (frame display) of an overlaid image overlaid on a preceding vehicle, which is an overlay target; and FIG. 1(C) is a diagram showing another example (alerting mark) of an overlaid image overlaid on a preceding vehicle, which is an overlay target.

FIG. 2(A) to FIG. 2(D) are diagrams showing an example of visibility control of an overlaid image performed in a state where an overlaid image is being displayed on a preceding vehicle, and another vehicle has cut in between the host vehicle and the preceding vehicle.

FIG. 3(A) to FIG. 3(C) are diagrams showing another example of visibility control of an overlaid image performed in a state where an overlaid image is being displayed on a preceding vehicle, and another vehicle has cut in between the host vehicle and the preceding vehicle (an example of controlling the visibility according to the distance between the host vehicle and the preceding vehicle); FIG. 3(D) is a diagram showing in a table format an example of the visibility control performed with respect to the preceding vehicle (non-cut-in object: first object); and FIG. 3(E) is a diagram showing in a table format an example of the visibility control performed with respect to the other vehicle (cut-in object: second object).

FIG. 4(A) to FIG. 4(C) are diagrams showing an example of visibility control of an overlaid image performed in a state where an overlaid image is being displayed on a preceding vehicle, and an object having a higher relative speed has appeared in front of the preceding vehicle.

FIG. 5(A) to FIG. 5(C) are diagrams showing an example of visibility control of an overlaid image performed in a state where an overlaid image is being displayed on each of a plurality of preceding vehicles, and another vehicle has cut in between the host vehicle and the nearest preceding vehicle.

FIG. 6(A) is a diagram showing a configuration example of the main parts of a HUD apparatus; and FIG. 6(B) is a diagram showing a configuration example of a display control unit.

FIG. 7 is a flowchart showing a processing sequence when visibility control is carried out with respect to an overlaid image.

### MODE FOR CARRYING OUT THE INVENTION

The best embodiment described below is used so that the present invention is easily understood. Therefore, those skilled in the art should be aware that the present invention is not unduly limited by the embodiment described below.

The vehicle display apparatus of the present invention is mounted on a vehicle (host vehicle), and includes at least a head-up display (HUD) that projects an image on a projection target member (such as windshield) provided in the vehicle (host vehicle) that causes a driver to visually recognize a virtual image of the image, and the virtual image includes a virtual image of an overlaid image overlaid on a real view of the surroundings of the vehicle. Note that the vehicle represents a type of transport vehicle, and is to be broadly interpreted.

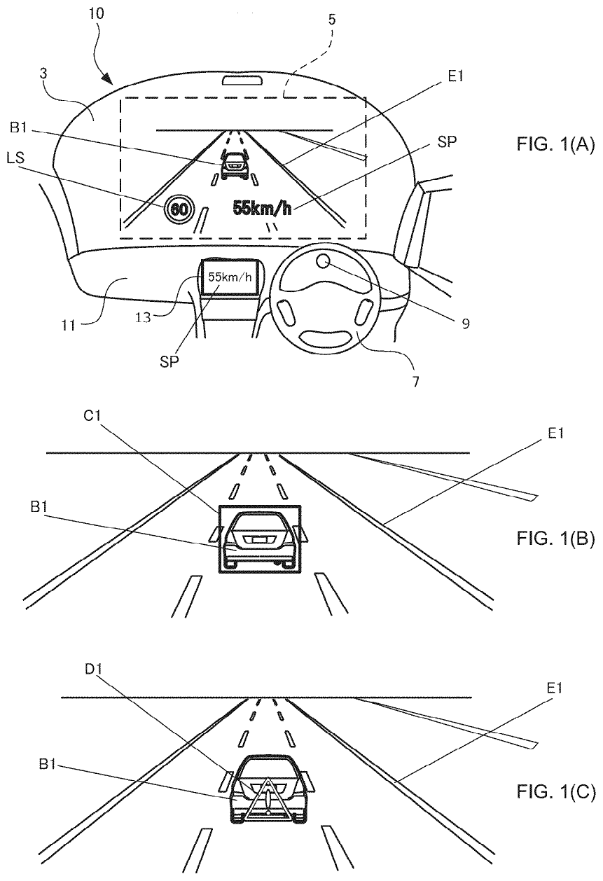

The following description refers to FIG. 1. FIG. 1(A) is a diagram showing a display example of a vehicle display apparatus including at least a head-up display (HUD); FIG. 1(B) is a diagram showing an example (frame display) of an overlaid image overlaid on a preceding vehicle, which is an overlay target; and FIG. 1(C) is a diagram showing another example (alerting mark) of an overlaid image overlaid on a preceding vehicle, which is an overlay target.

In the example of FIG. 1(A), a windshield (here, a front windscreen) 3 of a vehicle (host vehicle) 10 functions as the projection target member (translucent member). The steering wheel 7 is provided with an operation unit 9 which is capable of switching on/off a HUD apparatus or the like, and setting an operation mode or the like.

A display apparatus (such as a liquid crystal panel) 13 is arranged on the center of a front panel 11, and various types of information can be displayed as a real image in a display area of the display apparatus 13. In the example of FIG. 1(A), a display SP is generated which indicates a travel speed of “55 km/h”.

In the example of FIG. 1(A), the vehicle (host vehicle) 10 is traveling on a straight road, and a road (including a center line E1) and a preceding vehicle (first object) B1, which is the overlay target of the overlaid image, are visible in front of the vehicle as a real view.

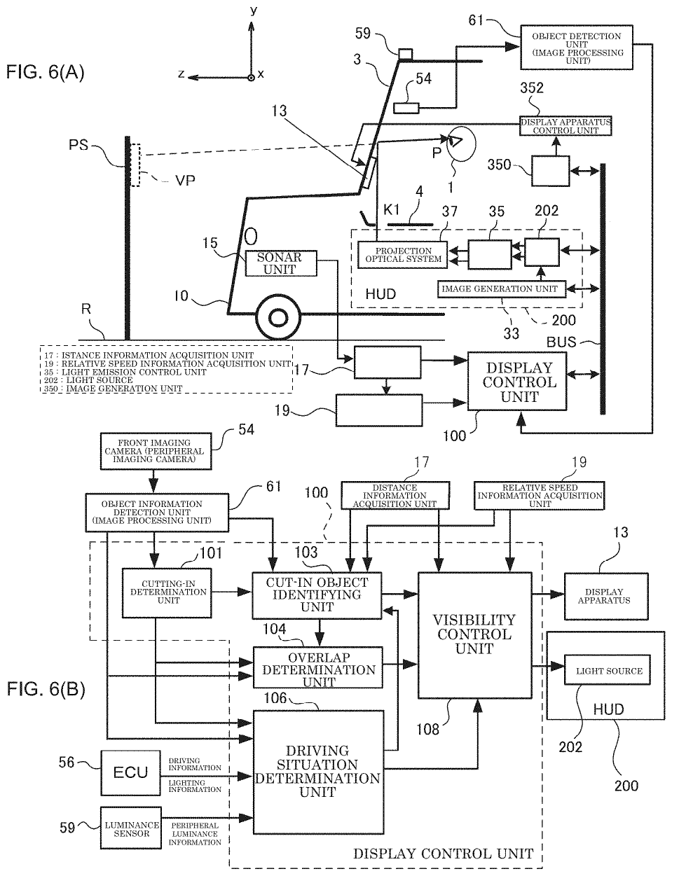

The driver (user) is capable of viewing an image (virtual image) formed by a HUD apparatus (not shown in FIG. 1(A), reference numeral 200 in FIG. 6) in front of the vehicle (host vehicle) 10 via the windshield 3. In the example of FIG. 1(A), a rectangular virtual display area (virtual image displayable area) 5 enclosed by the broken line is set on the surface of the windshield 3, and the image (virtual image) is capable of being displayed inside the virtual display area (virtual image displayable area) 5.

The example of FIG. 1(A) is exemplified by a display LS indicating the speed limit of the road and a display SP indicating the travel speed of the vehicle 10 (“55 km/h” in this case) are displayed as an image (virtual image) by the HUD apparatus.

The following description refers to FIG. 1(B) and FIG. 1(C). As shown in FIG. 1(B), using the HUD apparatus, an overlaid image C1 (virtual image) having a frame that encloses an overlay target is overlaid on a preceding vehicle (overlay target) B1. A frame display is highly effective for emphasizing an overlay target, and is highly effective for drawing the attention of (and alerting) the driver (user). Although the frame is a square-shaped frame (square frame) in FIG. 1(B), it is not limited to this and may be any shape such as a circular frame.

When the overlaid image is an image that encloses the object with a frame, although there is an advantage that the object can be emphasized more clearly, the area of the graphic constituted by the frame becomes large, and therefore, when a plurality of overlay targets are present, there is a tendency for the frames to become more likely to overlap with each other and the like.

Furthermore, in FIG. 1(C), an alerting mark D1 (virtual image) representing the overlaid image is overlaid on the rear surface of the preceding vehicle B1.

Here, the overlaid image is broadly interpreted, and is sometimes referred to as an overlaid display, overlaid content, an emphasis display, an emphasis mark, an alerting display, an alerting mark, and the like.

Furthermore, in the vehicle display apparatus in FIG. 1(A), the display of the display apparatus 13 and the display of the HUD apparatus can be used together. For example, when it is difficult to see the virtual image of the HUD apparatus at night or due to bad weather, the display area of the display apparatus 13 may display the preceding vehicle B1 and the overlaid images (real images) C1 and D1 shown in FIG. 1(B) and FIG. 1(C). In other words, the display of the overlaid image on the overlay target (overlay display) can be performed using at least either of the HUD apparatus or the display apparatus 13.

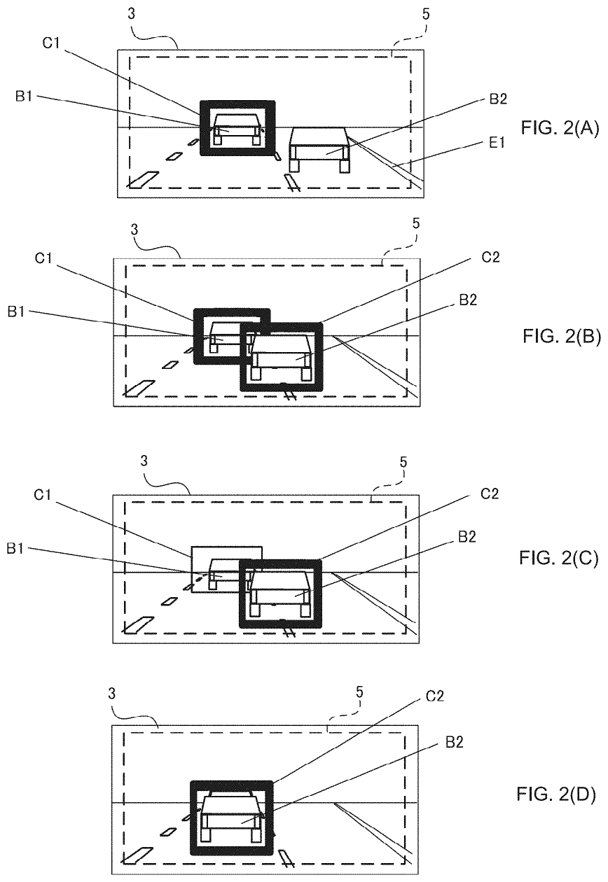

The description will be continued with reference to FIG. 2. FIG. 2(A) to FIG. 2(D) are diagrams showing an example of visibility control of an overlaid image performed in a state where an overlaid image is being displayed on a preceding vehicle, and another vehicle has cut in between the host vehicle and the preceding vehicle. Note that, in FIG. 2, the same parts as those in FIG. 1 are assigned the same reference numerals (the same applies to the subsequent drawings).

FIG. 2(A) shows a situation where a first overlaid image (a square frame display in this case) C1 is being overlaid on a first object B1, which is the preceding vehicle, and a second object B2, which is the cut-in object, has cut in between the host vehicle 10 and the preceding vehicle (first object) B1.

In FIG. 2(B), a situation has occurred where a second overlaid image C2 overlaid on a second object B2, which is the cut-in object, overlaps (or partially overlaps) a first overlaid image C1 overlaid on a first object (preceding vehicle) B1, or the first object B1 itself, or a situation has occurred where the first overlaid image C1 overlaps the second object (cut-in vehicle) B2. When such an overlap occurs, the correspondence relationship between the overlaid images and objects becomes unclear, which can result in confusion for the driver (user).

Therefore, as shown in FIG. 2(C), a display control is executed that makes the visibility of the first overlaid image C1 lower than the visibility of the second overlaid image C2. For example, the display luminance of the first overlaid image C1 (sometimes represented by the transmittance) is made lower than the display luminance of the second overlaid image C2. As a result, for example, even if the overlaid images partially overlap each other, the relatively increased visibility of the second overlaid image enables it to be easily distinguished from the first overlaid image, and therefore, the attention of the driver (user) can be focused (directed) without delay or confusion toward the second object (in other words, the cut-in vehicle B2, which is a cut-in object that has newly appeared), and further, the driver (user) is capable of quickly recognizing (for example, intuitively recognizing) the cut-in object (second object) B2. Therefore, when danger exists, it becomes easier to take an appropriate measure such as stepping on the brakes or avoiding a collision by operating the steering wheel with an appropriate timing, and the convenience of the vehicle display apparatus, such as the HUD (head-up display), is improved.

Note that the “visibility” refers to how easily visual confirmation can be made on sight. In addition to changing the luminance or brightness of an overlaid image, the methods of changing the visibility are exemplified by changing the shapes, patterns, colors, or connections of a symbol (such as geometric shape) or character that constitutes the overlaid image, changing the thickness of the lines that constitute a symbol (such as a geometric shape), changing the thickness of a character, adding a character or the like for attracting attention to a symbol, and changing the light emission state (for example, blinking) of a symbol (however, the present invention is not to be interpreted as being limited to these, and is to be broadly interpreted).

In FIG. 2(D), the second object B2, which is the cut-in object, and the first object B1, which is the preceding vehicle, almost entirely overlap, and in this case, because the first overlaid image (the frame image of the preceding vehicle) C1 becomes unnecessary, the first overlaid image C1 is, for example, removed or displayed with a significantly lowered visibility.

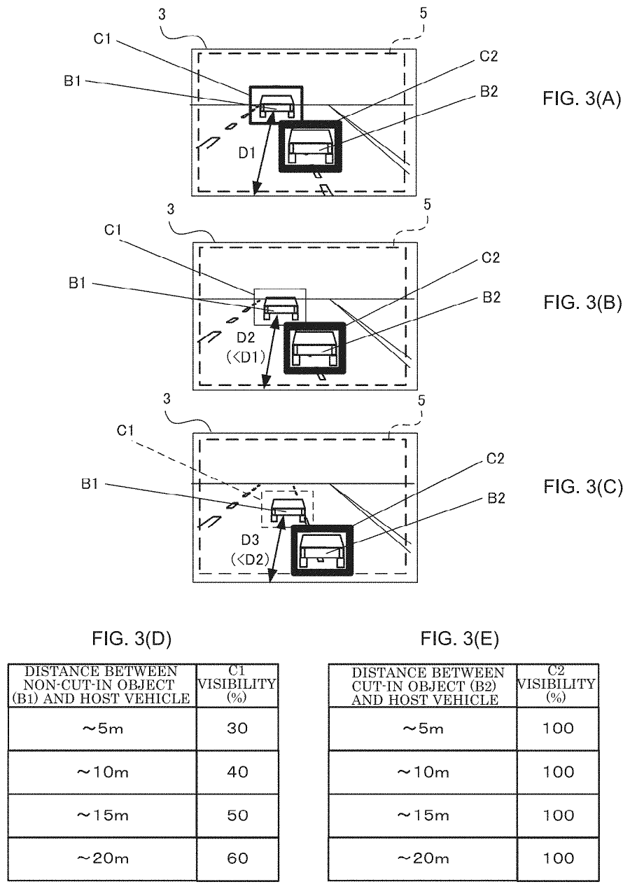

The description will be continued with reference to FIG. 3. FIG. 3(A) to FIG. 3(C) are diagrams showing another example of visibility control of an overlaid image performed in a state where an overlaid image is being displayed on a preceding vehicle, and another vehicle has cut in between the host vehicle and the preceding vehicle (an example of controlling the visibility according to the distance between the host vehicle and the preceding vehicle); FIG. 3(D) is a diagram showing in a table format an example of the visibility control performed with respect to the preceding vehicle (non-cut-in object: first object); and FIG. 3(E) is a diagram showing in a table format an example of the visibility control performed with respect to the other vehicle (cut-in object: second object).

In the example of FIG. 3, a control is similarly executed that makes the visibility of the first overlaid image C1 lower than the visibility of the second overlaid image C2; however, in the example of FIG. 3, the extent that the visibility is lowered is varied depending on the distance between the host vehicle 10 and the first object (preceding vehicle) C1.

In FIG. 3(A) to FIG. 3(C), the relative positional relationship between the preceding vehicle (first object: also referred to as a non-cut-in object) B1 and the cut-in vehicle (second object) B2 is the same. However, the inter-vehicle distance between the host vehicle 10 and the preceding vehicle (first object) B1 is D1 in FIG. 3(A), D2 (D2<D1) in (B), and D3 (D3<D2) in (C), such that the inter-vehicle distance becomes successively smaller from (A) to (C).

The visibility (in this case, for example, the luminance or brightness of the frame) of the first overlaid image (a square frame display) C1 overlaid on the preceding vehicle (first object; non-cut-in object) is successively lowered from (A) to (C) according to the change in the inter-vehicle distance.

The visibility of the first overlaid image C1 is, for example, determined according to the table shown in FIG. 3(D) based on the inter-vehicle distance between the preceding vehicle (first object: non-cut-in object) B1 and the cut-in vehicle (second object) B2. The transmittance (visibility) is 30% at an inter-vehicle distance of less than 5 m, the transmittance (visibility) is 40% at 5 m or more and less than 10 m, the transmittance (visibility) is 50% at 10 m or more and less than 15 m, and the transmittance (visibility) is 60% at 15 m or more and less than 20 m.

On the other hand, the visibility (in this case, the luminance or brightness) of the second overlaid image C2 overlaid on the cut-in vehicle (second object: also referred to as the cut-in object) B2 is determined, for example, according to the table shown in FIG. 3(E). In the table shown in FIG. 3(E), the transmittance of the second overlaid image C2 is uniformly set to 100% (the maximum luminance or maximum brightness) irrespective of the classification of the inter-vehicle distance above. The cut-in vehicle (second object: cut-in object) B2 is considered to pose a higher level of danger than the preceding vehicle (first object: non-cut-in object) B1, and further, when the driver (user) is alerted, it is considered better for the gaze to be concentrated (focused) toward B2; however, if the luminance or brightness of the second overlaid image C2 is varied at this time according to the inter-vehicle distance, this may cause the image to flicker or become more difficult to view, and therefore, it is uniformly displayed here with the maximum luminance (however, it is not limited to this, and the transmittance may be varied as necessary according to the inter-vehicle distance).

FIG. 3(A) illustrates a case where another vehicle B2 has cut in when the inter-vehicle distance between the host vehicle 10 and the preceding vehicle (first object) B1 is large (a first distance D1), and therefore, it can be assumed that the inter-vehicle distance D1 with the cut-in vehicle B2 is usually relatively large with some room to spare.

FIG. 3(B) illustrates a case where another vehicle B2 has cut in when the inter-vehicle distance between the host vehicle 10 and the preceding vehicle (first object) B1 is small (a second distance D2, D2<D1)), and therefore, it is highly probable that the vehicle has very aggressively cut into a small space, and it can be assumed that the inter-vehicle distance with the cut-in vehicle (second object) B2 is relatively small with little room to spare, and the situation is more dangerous.

FIG. 3(C) illustrates a case where another vehicle B2 has cut in when the inter-vehicle distance between the host vehicle 10 and the preceding vehicle (first object) B1 is even smaller (a third distance D3, D3<D2<D1)), and therefore, this is a case where the vehicle has very aggressively cut into an even smaller space, and it can be assumed that the inter-vehicle distance with the cut-in vehicle (second object) B2 is even smaller with no room to spare, and the situation is even more dangerous.

Therefore, as the danger increases, the visibility of the first overlaid image C1 is lowered so that the level of attention toward the cut-in vehicle (second object) B2 increases.

When the visibility of the second overlaid image C2 is Q2 in FIG. 3(A), the visibility of the first overlaid image C1 is Q1a, the visibility of the first overlaid image C1 in FIG. 3(B) is Q1b, and the visibility of the first overlaid image C1 in FIG. 3(C) is Q1c, then the relationship Q2>Q1a>Q1b>Q1c is established.

For example, when there is overlap between the second overlaid image C2 and the first overlaid image C1, the relative difference in visibility (visibility difference) is larger when the visibilities of the images are Q2 and Q1b (the case of FIG. 3(B) than when the visibilities of the images are Q2 and Q1a (the case of FIG. 3(A), and it becomes less likely for attention to be directed toward the first object B1 and more likely for attention to be directed toward the second object B2. Therefore, the cut-in vehicle (second object) B2 is more emphasized and more likely to draw the attention of the driver (user). In other words, when there is more danger, the attention of the driver (user) can be more focused (directed) toward the cut-in vehicle (second object) B2. As a result, brake and steering wheel operations and the like are more likely to be performed without delay, and it is possible to obtain an effect such as increasing the probability of risk avoidance.

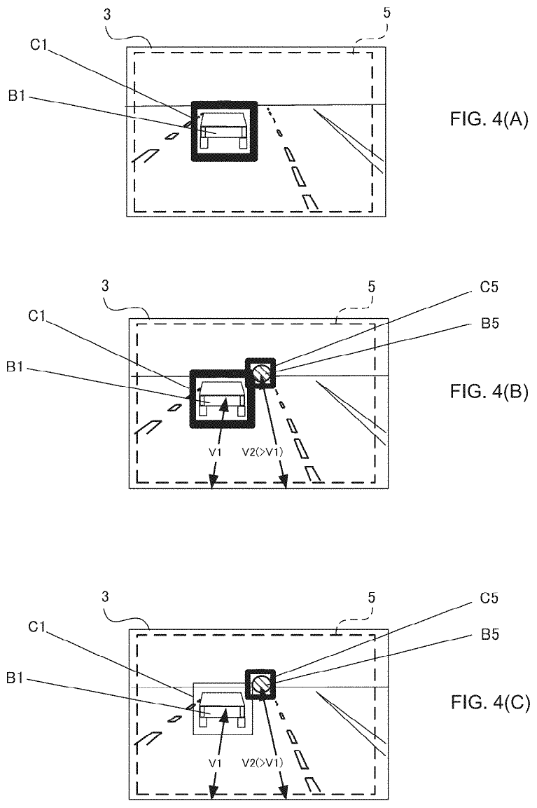

The description will be continued with reference to FIG. 4. FIG. 4(A) to FIG. 4(C) are diagrams showing an example of visibility control of an overlaid image performed in a state where an overlaid image is being displayed on a preceding vehicle, and an object having a higher relative speed has appeared in front of the preceding vehicle.

In the example of FIG. 4, when an object (overlay target) B5 on which an overlaid image is to be displayed newly appears in front of the first object (preceding vehicle) B1, and the relative speed V2 of the newly appeared object (overlay target) B5, when referenced to the host vehicle 10, is higher than the relative speed V1 of the first object B1, then the newly appeared object (overlay target) B5 is identified as the second object, which is the cut-in object, and further, when overlap has occurred between the overlaid images and the like, the visibility control described above is executed.

As an example of a case where an object (overlay target) representing an overlay target of the overlaid image newly appears in front of the preceding vehicle (first object) B1, a case is plausible where another vehicle traveling at high speed passes the host vehicle 10, and then additionally passes the preceding vehicle B1 in front of the host vehicle and changes course into the same driving lane as the host vehicle 10; however, in this case, the overlay target is positioned further away than the preceding vehicle and the like (first object) and is also moving further away from the host vehicle, and therefore, the danger is not considered to be very high, and the need to focus (direct) the attention of the driver (user) on the overlay target is considered to be low.

However, as shown in FIG. 4(B), when an overlay target B5 newly and unexpectedly appears in front of the preceding vehicle (first object) 10 in the situation shown in FIG. 4(A), and the overlay target B5 is, for example, a stationary object (such as an object that has fallen from the loading platform of a preceding truck, a rock caused by a landslide, a protrusion caused by an earthquake, or a car that has stopped in the driving lane due to a sudden breakdown), or is not a stationary object but is an object whose travel speed is very slow (such as an automobile with elderly passengers, an agricultural cultivator traveling on the road, or a snowplow traveling while removing snow), the inter-vehicle distance with the host vehicle 10 will immediately become small such that delayed discovery will cause the possibility of a collision to increase, and therefore, such an overlay target B5 can be considered a highly dangerous object. Furthermore, the danger is even greater when the object is a vehicle traveling in the wrong direction, an oncoming vehicle that has crossed the center line, or a person approaching the host vehicle on a bicycle or the like.

In this case, the relative speed V2 of the overlay target B5, when referenced to the host vehicle 10, is higher than the relative speed V1 of the first object (such as the preceding vehicle B1, which is a moving object and is traveling so as to maintain the inter-vehicle distance with the host vehicle), and the relationship V2>V1 is established. Note that the relative speed can be calculated by detecting the change in the distance between the host vehicle and the object over time.

Therefore, in such a case, if there is overlap (as in the case of FIG. 4(B)) between the overlaid image C5 of the overlay target B5 and the overlaid image (first overlaid image) C1 of the first object B1 positioned behind it (or overlap with the first object B1), the overlay target B5 is identified as the second object (cut-in object) described above so that the attention of the driver (user) can be focused (directed) toward the overlay target B5, and further, the visibility control (a display control that lowers the visibility of the first overlaid image C1 so that the second overlaid image C5 of the second object is more emphasized) is executed (FIG. 4(C)).

As a result, even in a situation where an object (first object) B1 is present in front of the host vehicle 10 (FIG. 4(A)), and an additional object B5 with a large relative speed unexpectedly appears in front of the object, the driver (user) can direct attention to the object B5 which is more dangerous than the first object B1 without delay, and can take an appropriate action with an appropriate timing. Therefore, the convenience of the vehicle display apparatus is improved.

According to the example of FIG. 4, the effect of being able to quickly recognize and direct attention toward the cut-in object can be obtained even when the overlay targets are a mixture of moving objects and stationary objects (or objects that have a very low movement speed: near-stationary objects) and the like.

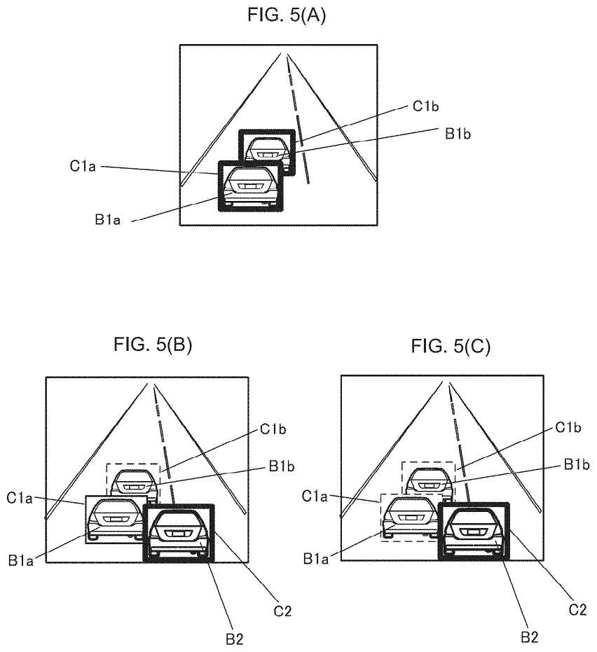

The description will be continued with reference to FIG. 5. FIG. 5(A) to FIG. 5(C) are diagrams showing an example of visibility control of an overlaid image performed in a state where an overlaid image is being displayed on each of a plurality of preceding vehicles, and another vehicle has cut in between the host vehicle and the nearest preceding vehicle.

In FIG. 5(A), a plurality (two or more) of preceding vehicles (first objects) B1a and B1b are present, and the first overlaid images C1a and C1b are overlaid on the vehicles.

In FIG. 5(B), a cut-in vehicle (second object) C2 has appeared, and the second overlaid image C2 overlaps with the plurality (two or more) preceding vehicles (first objects) B1a and B1b (or the first overlaid images C1a and C

In FIG. 5(B), by lowering the visibility of the first overlaid images C1a and C1b according to the distance from the vehicle (host vehicle) 20, a visibility control is executed such that, for example, the visibility of the second overlaid image C2 of the cut-in vehicle (second object) B2 is the highest, the visibility of the first overlaid image C1a of the object B1a, which is closest to the host vehicle 10 among the two or more first objects, is the next highest, and the visibility of the first overlaid image C1b of the object Bib which is farthest from the host vehicle 10 is the lowest. As a result, the driver (user) is capable of intuitively recognizing (grasping) the distance to each object or the level of danger of each object, and therefore, even in a case where a plurality of overlay targets are present, an appropriate measure can be taken while paying appropriate attention to each target, and paying the greatest attention to the cut-in object (second object).

Furthermore, in FIG. 5(C), when the number of first objects Ma and B1b is two or more, the visibility of the first overlaid images C1a and C1b of the first objects B1a and B1b is uniformly lowered (by the same level). As a result, the driver (user) is capable of paying the maximum attention to the cut-in object (second object) B2, and further, because the visibility of the two or more first objects Ma and B1b is uniformly lowered, the possibility of visual confusion is also reduced.

The description will be continued with reference to FIG. 6. FIG. 6(A) is a diagram showing a configuration example of the main parts of a HUD apparatus, and FIG. 6(B) is a diagram showing a configuration example of a display control unit. In FIG. 6(A), the direction orthogonal to the flat road surface R and extending away from the road surface is the Y direction (upward direction), the forward direction is the Z direction, and the width direction of the vehicle 10 is the X direction.

As shown in FIG. 6(A), the vehicle (host vehicle) 10 includes a display apparatus 13 (a liquid crystal display apparatus, which may also be the display apparatus of an electronic mirror system), a sonar unit (radar unit: distance measuring means) 15, a distance information acquisition unit 17, a relative speed information acquisition unit 19, a peripheral imaging camera (in this case, a front and side imaging camera) 54, a luminance sensor (ambient light intensity sensor) 59, an object detection unit (object information acquisition unit: image processing unit) 61, a display control unit 100, a HUD apparatus 200, an image generation unit 350 for the display apparatus 13, and a display apparatus control unit 352 for the display apparatus 13.

Note that, in the case of a vehicle which is not provided with the sonar unit (radar unit: distance measuring means) 15, the distance between an overlay target and the host vehicle may be measured (detected) by image processing performed by the object detection unit (image processing unit) 61.

The HUD apparatus 200 is, for example, installed inside the dashboard 4. The HUD apparatus 200 includes an image generation unit 33, a light emission control unit 35, a projection optical system 37, and a light source 202.

The display control unit 100 is electrically connected to the light source 202, the image generation unit 33, and the display apparatus control unit 352 of the HUD apparatus 200 via a bus. The display control unit 100 is capable of controlling the visibility of the first overlaid image mentioned above.

The display light K1 emitted upward from the projection optical system 37 of the HUD apparatus 200 is projected on the windshield (the front windscreen in this case) 3 serving as the projection target member of the vehicle 10, and a portion of the light is reflected and is directed toward the eyes (perspective) P of the driver 1. As a result, the first overlaid image (overlaid content) described above, and a display which includes the speed limit or the vehicle speed (non-overlaid content) are displayed, for example, on a virtual display surface PS positioned in front of the driver 1 and a predetermined distance away from the vehicle 10.

The description will be continued with reference to FIG. 6(B). The display control unit 100 includes: a cutting-in determination unit 101 that determines whether cutting-in has occurred; a cut-in object identifying unit 103 that identifies the cut-in object (second object); an overlap determination unit 104 that determines the presence or absence of overlap between the second overlaid image and the first overlaid image (or the first object itself); a driving situation determination unit 106 that determines the driving situation (such as a driving scene) based on information from the engine control unit (ECU) 56 or the luminance sensor 59; and a visibility control unit 108 that executes a visibility control with respect to the first overlaid image (such as an emphasizing display frame or an alerting mark).

Note that, depending on the driving situation, because execution of the visibility control of the first overlaid image is not preferable in some cases, the determination information generated by the driving situation determination unit 106 is supplied to the visibility control unit 108 as appropriate.

The visibility control unit 108 is capable of performing, for example, a level-based control of the visibility of the display image (including the first overlaid image) by controlling the display gradation of the display apparatus 13 and the emission brightness of the light source 202 provided in the HUD apparatus 200. However, it is not limited to this, and a linear control may be performed.

When the cutting-in determination unit 101 has determined that a cut-in has occurred, the cut-in object identifying unit 103 has identified the cut-in object (second object), the overlap determination unit has determined that there is (or could be) overlap between the first overlaid images described above, or has established from information from the driving situation determination unit 106 that there is no problem in the current situation for the visibility control to be performed, the visibility control unit 108 executes the visibility control of the first overlaid images and the like as illustrated in FIG. 2 to FIG. 5. At this time, the visibility control unit 108 can refer to information such as the distance information and relative speed information of the overlay targets as appropriate.

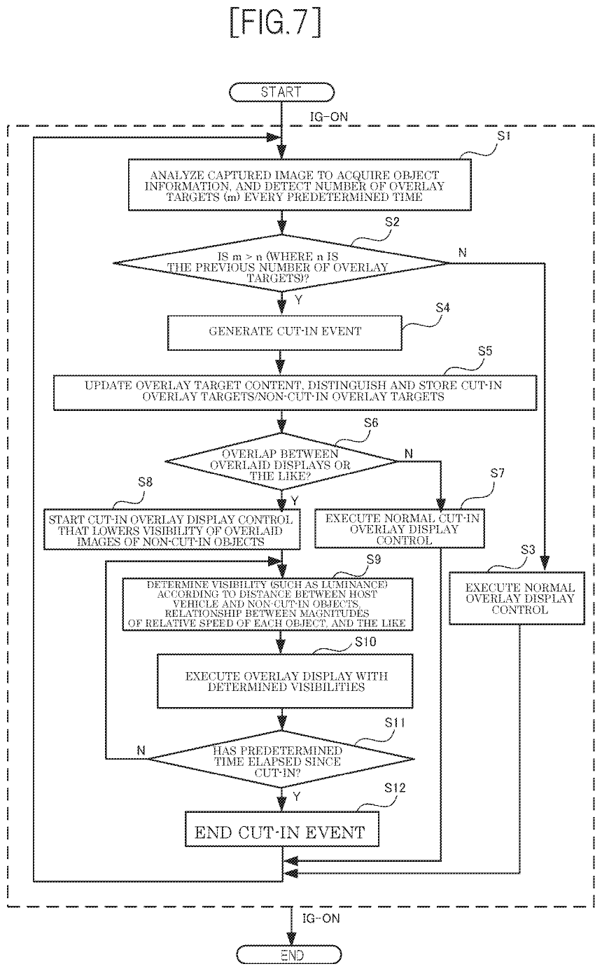

The description will be continued with reference to FIG. 7. FIG. 7 is a flowchart showing a processing sequence when visibility control is carried out with respect to an overlaid image.

The vehicle display apparatus is activated when the ignition switch of the vehicle is turned on, and while the vehicle is traveling, the object detection unit 61 acquires object information (detects objects) by analyzing images captured by the peripheral imaging camera 54, identifies overlay targets, and detects the number of overlay targets (m) at every predetermined time (step S1).

The cutting-in determination unit 101 compares the number of overlay targets (n) detected at the previous timing with the number of overlay targets (m) detected this time, and determines whether or not m>n (in other words, whether or not the number of overlay targets has increased) (step S2).

If the result of step S2 is N, the visibility control unit 108 executes a normal (a regular driving state without cutting-in) overlay display control (step S3).

If the result of step S2 is Y (in other words, the number of overlay targets has increased), the cut-in object identifying unit 103 determines that cutting-in has occurred (a cut-in object has appeared), identifies the cut-in object (including the type of object and level of danger and the like), and generates a cut-in event (step S4).

The overlap determination unit 104 and the visibility control unit 108, for example, update the content relating to the overlay targets in a data table held therein, and store the cut-in objects (second objects) and the non-cut-in objects (first objects) such that they are distinguished (step S5).

The overlap determination unit 104 determines whether or not there is (or could be) overlap between overlaid images, or between an overlaid image and an object (overlap between objects may also be subjected to this determination if necessary) (step S6).

If the result of step S6 is N, the visibility control unit 108 executes a normal cut-in overlay display control (step S7).

If the result of step S6 is Y (in other words, there is overlap or could be overlap), the visibility control unit 108 starts to execute a cut-in overlay display control that lowers the visibility of the overlay display of the non-cut-in objects (first objects) (step S8).

The visibility control unit 108, for example, as shown in the examples of FIG. 3 and FIG. 5(B), determines the visibility of the first overlaid image (such as an emphasizing display frame or an alerting mark) according to the distance between the host vehicle and the non-cut-in objects (first objects), or as shown in the example of FIG. 4, according to the relationship between the magnitudes of the relative speeds of the non-cut-in object (first object) and the cut-in object (second object) (step S9), and executes an overlay display with the determined visibility (step S10).

In step S11, it is determined whether or not a predetermined time has elapsed since the generation of the cut-in event, and if the result is N, the process returns to step S9 and the visibility control of the overlay display is executed, and if the result is Y, the cut-in event ends (step S12). The steps above are repeatedly executed while the vehicle is traveling.

As described above, with respect to a head-up display (HUD) apparatus or the like, the embodiments of the present invention are capable of preventing a driver (user) from becoming confused when, for example, the number of overlaid images for alerting or emphasizing or the like that are overlaid on an object increases due to the cutting-in of a vehicle, resulting in overlap between the overlaid images or between an overlaid image and another object, and causing an unclear correspondence relationship between the overlaid images and objects.

The present invention is not limited to the exemplary embodiments described above, and those skilled in the art can easily modify the exemplary embodiments described above in a scope included in the scope of the claims

### DESCRIPTION OF REFERENCE NUMERALS

1 Driver
3 Windshield
4 Dashboard
5 Virtual display area (virtual image displayable area)
7 Steering wheel
9 Operation unit (operation switch)
10 Vehicle (host vehicle)
13 Display apparatus (display panel)
33 Image generation unit (for HUD)
35 Light emission control unit
37 Projection optical system
54 Peripheral imaging camera
56 ECU
59 Luminance sensor (ambient light intensity sensor)
100 Display control unit
101 Cutting-in determination unit
103 Cut-in object identifying unit
104 Overlap determination unit
106 Driving situation determination unit
108 Visibility control unit
200 HUD apparatus
202 Light source
350 Image generation unit (for display apparatus)
352 Display apparatus control unit
K1 Display light
PS Virtual image display surface
B1 First object (e.g. non-cut-in object, preceding vehicle)
B2 Second object (e.g. cut-in object, cut-in vehicle)
C1 First overlaid image overlaid on first object
C2 Second overlaid image overlaid on second object

1. A vehicle display apparatus mounted on a vehicle, and including at least a head-up display (HUD) that projects an image on a projection target member provided in the vehicle that causes a driver to visually recognize a virtual image of the image, and the virtual image includes a virtual image of an overlaid image overlaid on a real view of the surroundings of the vehicle,
the vehicle display apparatus comprising
a display control unit that acquires a position of an object included in the real view of the surroundings of the vehicle that can be an overlay target of the overlaid image, and displays the overlaid image overlaid on the detected object, wherein
the display control unit includes an overlap determination unit that, if a first overlaid image is overlaid on a first object and a second object is detected as a cut-in object, determines the presence or absence of overlap between a second overlaid image, which is overlaid on the second object, and the first overlaid image or the first object, or the presence or absence of overlap between the first overlaid image and the second object, and
a visibility control unit that, if the overlap has occurred, makes a visibility of the first overlaid image lower than a visibility of the second overlaid image.

2. The vehicle display apparatus according to claim 1, wherein
the visibility control unit, given a visibility of the first overlaid image of Q1a when the vehicle and the first object are at a first distance, a visibility of Q1b at a second distance which is shorter than the first distance, and a visibility of the second overlaid image of Q2, controls a display of the first overlaid image such that Q2>Q1a>Q1b.

3. The vehicle display apparatus according to claim 1, wherein
the display control unit, if a first overlaid image is being overlaid on a first object, and an object having a higher relative speed than a relative speed between the vehicle and the first object is newly detected in front of the first object, identifies the detected object as the second object, which is the cut-in object, and causes the overlap determination unit to execute overlap determination processing and the visibility control unit to execute visibility reduction processing.

4. The vehicle display apparatus according to claim 1, wherein
if the number of first objects is two or more, the visibility control unit makes the visibility of the first overlaid image of each of the two or more first objects lower than the visibility of the second overlaid image, and changes the extent that the visibility is lowered according to a distance between the vehicle and each of the two or more first objects, or uniformly makes the visibility lower than the visibility of the second overlaid image.

5. The vehicle display apparatus according to claim 1, wherein
the overlaid image is displayed in at least either of a virtual image displayable area in the head-up display (HUD) apparatus, and a display area of a display apparatus disposed in front of the driver.

6. The vehicle display apparatus according to claim 1, wherein
each of the first and second overlaid images include a frame image that encloses each of the first and second objects.

7. The vehicle display apparatus according to claim 2, wherein
the display control unit, if a first overlaid image is being overlaid on a first object, and an object having a higher relative speed than a relative speed between the vehicle and the first object is newly detected in front of the first object, identifies the detected object as the second object, which is the cut-in object, and causes the overlap determination unit to execute overlap determination processing and the visibility control unit to execute visibility reduction processing.
